(19) United States
(12) Patent Application Publication
(10) Pub. No.: US 2014/0379649 A1
(43) Pub. Date: Dec. 25, 2014

(54) DISTRIBUTED STORAGE SYSTEM AND FILE SYNCHRONIZATION METHOD

(71) Applicants: HONG FU JIN PRECISION INDUSTRY (ShenZhen) CO.,LTD., Shenzhen (CN); HON HAI PRECISION INDUSTRY CO., LTD., New Taipei (TW)

(72) Inventors: Chung-I Lee, New Taipei (TW); Hai-Hong Lin, Shenzhen (CN); Da-Peng Li, Shenzhen (CN)

(21) Appl. No.: 13/813,671

(22) PCT Filed: Jul. 18, 2012
(86) PCT No.: PCT/CN12/78808

§ 371 Date: Feb. 1, 2013

(30) Foreign Application Priority Data
Feb. 28, 2012 (CN) 201210047314.8

(51) Int. Cl. G06F 17/30

(52) U.S. Cl. CPC G06F 17/30174
USPC 707/626

(57) ABSTRACT

A distributed storage system receives a file from a client, stores the file into different storage units in the system, creates a system log in an access entry and creates a unit log in each storage unit. The system log records information of all files stored in the system, and the unit log in each storage unit records information of all files stored in the storage unit. When a file stored in a first storage unit is lost or destroyed, the system determines a second storage unit that stores the same file as the first storage unit according to the information recorded in the system log and the unit logs, and repairs the file in the first storage unit by copying the same file from the second storage unit to the first storage unit.

### BACKGROUND

1. Technical Field

Embodiments of the present disclosure relate to file management systems and methods, and more particularly to a distributed storage system and a file synchronization method.

2. Description of related art

File synchronization is required by a distributed storage system. In one synchronization mechanism, a metadata server may be used to maintain all files stored within the distributed storage system. If a file stored in the distributed storage system is deleted or corrupted, the metadata file replaces or repairs the file using data stored in the metadata. This synchronization mechanism can repair destroyed files in a short time, however, with an increase of the number of files stored within the distributed storage system, data stored in the metadata also increases, which may decrease synchronization speed of the file synchronization and increase the likelihood of errors concerning data in the metadata server.

### BRIEF DESCRIPTION OF THE DRAWINGS

FIG. 1 is a block diagram of one embodiment of a distributed storage unit including a file synchronization system.

FIG. 2 is a block diagram of one embodiment of function modules of the file synchronization system.

FIG. 3 is a flowchart of one embodiment of a file synchronization method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

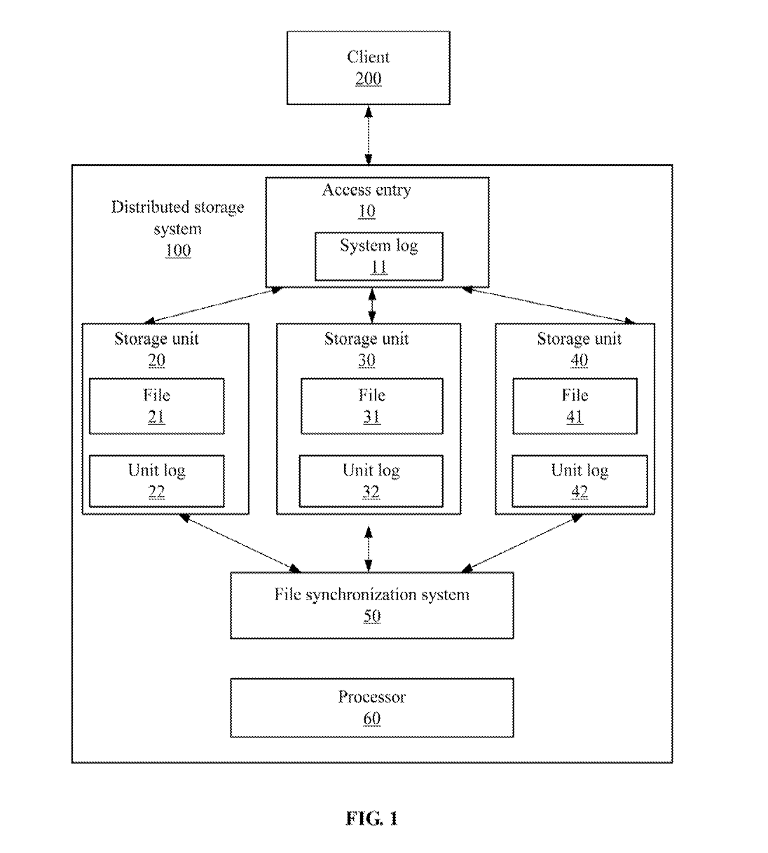

FIG. 1 is a block diagram of one embodiment of a distributed storage system 100. The distributed storage system 100 includes an access entry 10, one or more storage units, such as storage units 20-40 shown in FIG. 1, and a file synchronization system 50. A client 200 stores files into the distributed storage system 100 via the access entry 10. The access entry 10 provides an access protocol between the client 200 and the distributed storage system 100. For example, the access entry 10 may be a network file system, or a file transfer protocol. In order to protect data security, the same file may be stored into different storage spaces within the distributed storage system 100, such as any of the storage units 20-40. In this embodiment, the storage units 20-40 are different storage spaces provided by the same storage server. In another embodiment, the storage units 20-40 may be different storage spaces provided by different storage servers.

The file synchronization system 50 designates different storage paths to the same file, and stores the same file into different storage units in the distributed storage system 100 according to the designated storage paths. For example, a file A may be stored into the storage units 20, 30, and 40 as files 21, 31, and 41 respectively. The file synchronization system 50 further creates a system log 11 in the access entry 10 and creates a unit log in each storage unit, such as a unit log 22 in the storage unit 20, a unit log 32 in the storage unit 30, and a unit log 42 in the storage unit 40. The system log 11 records information of all files stored in the distributed storage system 100, and the unit log in each storage unit records information of all files stored in the storage unit. For example, the unit log 22 in the storage unit 20 records information of all files stored in the storage unit 20.

When a file (such as the file 21) stored in a first storage unit (such as the storage unit 20) is lost or destroyed or corrupted, the file synchronization system 50 determines the file to be repaired (such as the file 21) according to information stored within the system log 11 and the unit log of the storage unit, determines a second storage unit (such as the storage unit 30) that stores the same file (such as the file 31), and repairs the file to be repaired (such as the file 21) by copying the same file (such as the file 31) from the second storage unit to the first storage unit.

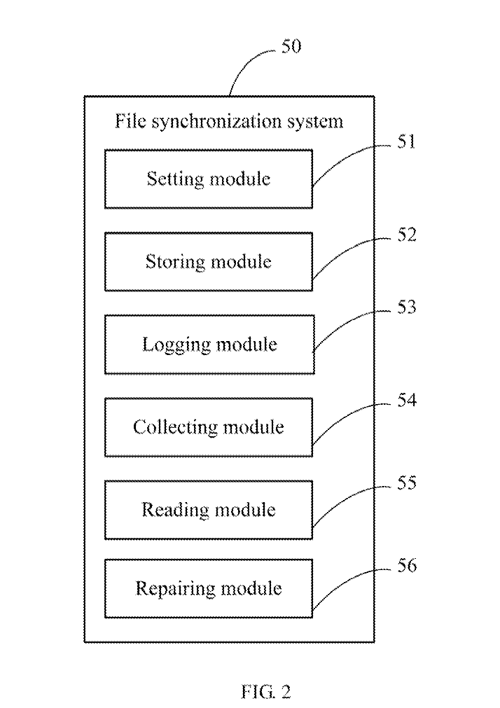

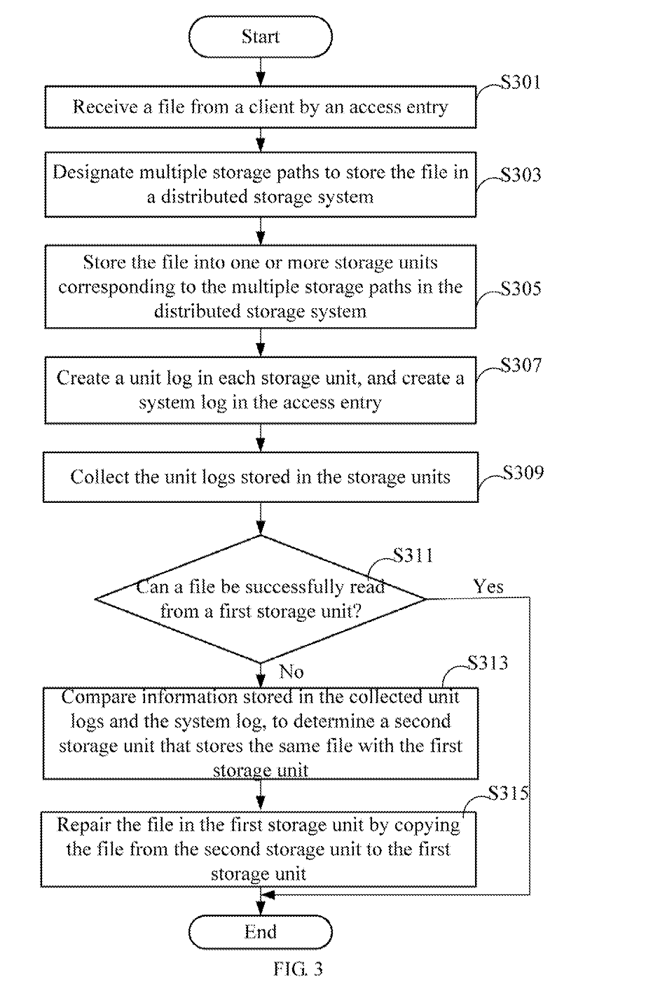

FIG. 2 is a block diagram of one embodiment of function modules of the file synchronization system 50. The file synchronization system 50 includes a setting module 51, a storing module 52, a logging module 53, a collecting module 54, a reading module 55, and a repairing module 56. The modules 51-56 may comprise computerized code in the form of one or more programs to be executed by a processor 60 of the distributed storage system 100. The computerized code of the modules 51-56 may be stored in one of the storage units of the distributed storage system 100, or may be stored in a storage space independent from the storage units. A detailed description of the functions of the modules 51-56 is given referring to FIG. 3.

FIG. 3 is a flowchart of one embodiment of a file synchronization method using the file synchronization system 50. Depending on the embodiment, additional steps may be added, others removed, and the ordering of the steps may be changed.

In step S301, the access entry 10 receives a file sent from the client 200. For example, the file with the name of “volume1” is received.

In step S303, the setting module 51 designates multiple storage paths to the file in the distributed storage system 100. For example, three storage paths “szunit01,” “szunit02,” and “szunit03” may be designated to the file “volume1.”

In step S305, the storing module 52 stores the file into one or more storage units corresponding to the multiple storage paths in the distributed storage system 100. For example, if the storage paths “szunit01,” “szunit02,” and “szunit03” respectively correspond to the storage units 20, 30, and 40, the file “volume1” is stored into the storage units 20, 30, and 40 as file 21, file 31, and file 41 respectively.

In step S307, the logging module 53 creates a system log 11 in the access entry 10 and creates a unit log in each storage unit, such as a unit log 22 in the storage unit 20, a unit log 32 in the storage unit 30, and a unit log 42 in the storage unit 40. The system log 11 records information of all files stored in the distributed storage system 100, and the unit log records information of all files stored in the storage unit. For example, the unit log 22 in the storage unit 20 records information of all files stored in the storage unit 20. Information of each file includes a name of the file, a volume of the file, creation time of the file, time when the file was last accessed, time when the file was last backed up, and a storage path of the file. The system log 11 includes all the information recorded in all of the unit logs.

In step S309, the collecting module 54 collects the unit logs stored in the storage units, and stores the collected unit logs in a preset storage location of the distributed storage system 100. Depending on the embodiment, the collecting operation may be periodically or aperiodically. In one embodiment, the preset storage location is storage space independent from the storage units, so that the collected unit logs are isolated and safe from damage to the storage units.

In step S311, the reading module 55 tries to read a file from a first storage unit, such as the file 21 from the storage unit 20, and determines if the file can be successfully read. In one embodiment, the reading operation may be enabled in response to an access request sent from the client 200, or in response to a request to check data security initiated by the distributed storage system 100. If the file can be successfully read from the first storage unit, the file is indicated to be normal (e.g., not corrupted and not deleted), and the procedure ends. Otherwise, if the file cannot be read from the first storage unit, the file is indicated to be corrupted or has been deleted, the procedure goes to step 5313.

In step S313, the repairing module 56 compares the collected unit logs and the system log 11, to determine a second storage unit that stores the same file. For example, if the file 21 is destroyed, by comparing the collected unit logs 22, 32, 42 and the system log 11, a determination may be made that the file 21 is a file having the name “volume1,” and that the files 31 and 41 are the same file as having the same file name “volume1” with the file 21.

In step S315, the repairing module 56 repairs the file in the first storage unit by copying the file from the second storage unit to the first storage unit. For example, the repairing module 56 repairs the file 21 by copying the file 31 from the storage unit 30 to the storage unit 20, or by copying the file 41 from the storage unit 40 to the storage unit 20.

The above embodiments store the same file in different storage paths of the distributed storage system and record file information in logs, so that a destroyed file can be quickly determined according to the logs and be repaired from the duplicate files.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A file synchronization method being executed by a processor of a distributed storage system, the method comprising:
receiving, via an access entry of the distributed storage system, a file sent from a client;
designating multiple storage paths to store the file in the distributed storage system;
storing the file into one or more storage units corresponding to the multiple storage paths in the distributed storage system;
creating a system log in the access entry and a unit log in each storage unit, wherein the system log records information of all files stored in the distributed storage system, and the unit log records information of all files stored in the storage unit;
collecting the unit logs stored in the storage units, and storing the collected unit logs in a preset storage location of the distributed storage system;
determining if the file can be successfully read from a first storage unit;
determining the file stored in the first storage unit is destroyed if the file fails to be read from the first storage unit, and determining a second storage unit that stores the same file by comparing the information recorded in the collected unit logs and the system log; and
repairing the file stored in the first storage unit by copying the same file from the second storage unit to the first storage unit.

2. The method of claim 1, wherein the access entry provides an access protocol between the client and the distributed storage system.

3. The method of claim 1, wherein the storage units are different storage spaces provided by one storage server, or different storage spaces provided by different storage servers.

4. The method of claim 1, wherein the information of each file comprises a name of the file, a volume of the file, creation time of the file, time that the file was last accessed, time that the file was last backed up, and a storage path of the file.

5. The method of claim 1, wherein collecting the unit logs stored in the storage units is performed periodically or aperiodically.

6. The method of claim 1, wherein the preset storage location is a storage space independent from the storage units.

7. A distributed storage system, comprising:
an access entry that receives a file sent from a client;
at least one processor;
non-transitory computer-readable storage memory having computer code stored thereon that, when executed by the at least one processor, causes the at least one processor to perform operations of:
designating multiple storage paths to store the file in the distributed storage system;
storing the file into one or more storage units corresponding to the multiple storage paths in the distributed storage system;
creating a system log in the access entry and a unit log in each storage unit, wherein the system log records information of all files stored in the distributed storage system, and the unit log records information of all files stored in the storage unit;
collecting the unit logs stored in the storage units, and storing the collected unit logs in a preset storage location of the distributed storage system;
determining if the file can be successfully reading from a first storage unit;
determining the file stored in the first storage unit is destroyed if the file fails to be read from the first storage unit, and determining a second storage unit that stores the same file by comparing the information recorded in the collected unit logs and the system log; and
repairing the file stored in the first storage unit by copying the same file from the second storage unit to the first storage unit.

8. The system of claim 7, wherein the access entry provides an access protocol between the client and the distributed storage system.

9. The system of claim 7, wherein the storage units are different storage spaces provided by one storage server, or different storage spaces provided by different storage servers.

10. The system of claim 7, wherein the information of each file comprises a name of the file, a volume of the file, creation time of the file, time that the file was last accessed, time that the file was last backed up, and a storage path of the file.

11. The system of claim 7, wherein collecting the unit logs stored in the storage units is performed periodically or aperiodically.

12. The system of claim 7, wherein the preset storage location is a storage space independent from the storage units.

13. A non-transitory computer-readable medium having stored thereon instructions that, when executed by a processor of a distributed storage system, causing the distributed storage system to perform a file synchronization method, the method comprising:
receiving a file, via an access entry of the distributed storage system, sent from a client;
designating multiple storage paths to store the file in the distributed storage system;
storing the file into one or more storage units corresponding to the multiple storage paths in the distributed storage system;
creating a system log in the access entry and a unit log in each storage unit, wherein the system log records information of all files stored in the distributed storage system, and the unit log records information of all files stored in the storage unit;
collecting the unit logs stored in the storage units, and storing the collected unit logs in a preset storage location of the distributed storage system;
determining if the file can be successfully reading from a first storage unit;
determining the file stored in the first storage unit is destroyed if the file fails to be read from the first storage unit, and determining a second storage unit that stores the same file by comparing the information recorded in the collected unit logs and the system log; and
repairing the file stored in the first storage unit by copying the same file from the second storage unit to the first storage unit.

14. The medium of claim 13, wherein the access entry provides an access protocol between the client and the distributed storage system.

15. The medium of claim 13, wherein the storage units are different storage spaces provided by one storage server, or different storage spaces provided by different storage servers.

16. The medium of claim 13, wherein the information of each file comprises a name of the file, a volume of the file, creation time of the file, time that the file was last accessed, time that the file was last backed up, and a storage path of the file.

17. The medium of claim 13, wherein collecting the unit logs stored in the storage units is performed periodically or aperiodically.

18. The medium of claim 13, wherein the preset storage location is a storage space independent from the storage units.
